(19) United States
(12) Patent Application Publication
(10) Pub. No.: US 2005/0210923 A1
(43) Pub. Date: Sep. 29, 2005

(54) Method of manufacturing precision glass spheres and method of manufacturing optical glass elements

(75) Inventors: Teruo Yamashita, Akishima-shi (JP); Shigeru Hayashi, Yokohama-shi (JP); Masahiro Yoshida, Hidaka-shi (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/052,749

(22) Filed: Feb. 9, 2005

(30) Foreign Application Priority Data
Feb. 10, 2004 (JP) 2004-32953

(51) Int. Cl. C03C 19/00

(52) U.S. Cl. 65/61; 65/64

(57) ABSTRACT

A method of manufacturing a precision glass sphere employed as a glass material (preform) in the molding of optical elements such as lenses, where the precision glass sphere that has been preformed with good weight precision and has an outer surface free of optically nonuniform layers. A method of manufacturing optical glass elements employing this precision glass sphere.

### FIELD OF THE INVENTION

The present invention relates to a method of manufacturing a precision glass sphere employed as a glass material (preform) in the molding of optical elements such as lenses, where the precision glass sphere that has been preformed with good weight precision and has an outer surface free of optically nonuniform layers. The present invention further relates to a method of manufacturing optical glass elements employing this precision glass sphere.

### BACKGROUND OF THE INVENTION

The method of press molding a glass material in a pressing mold that has been precision processed based on the final shape of a desired optical element (referred to as “precision press molding” hereinafter) to obtain an optical glass element such as a lens is known. This method is highly advantageous for manufacturing optical elements having aspherical surfaces, optical elements having minute patterns, and other optical elements that are difficult to form simply by grinding and polishing methods.

The use of a glass material that has been preformed to a prescribed shape or weight in such precision press molding is known. Known methods of manufacturing such glass materials are given below.

In one method, glass melt is solidified into glass blocks, which are then divided into pieces of glass material of prescribed weight and/or prescribed shape by cold processing in the form of cutting, grinding, polishing, or the like. For example, the glass block can be cut to obtain a cubic glass material, or fashioned into glass rods which are then cut to prescribed length to obtain a cylindrical glass material. These can then be further ground or polished to prescribed weight or shape.

Japanese Unexamined Patent Publication (KOKAI) Showa No. 61-261225 (Reference 1) describes a method of obtaining optical elements by polishing glass gobs to form glass spheres which are then hot press molded.

Japanese Unexamined Patent Publication (KOKAI) Heisei No. 6-227828 (Reference 2) describes a method of molding a glass material by cutting a glass material to prepare a glass preform of controlled volume, which is then hot processed with far infrared radiation to an approximately spherical shape and then ground to a spherical shape.

Japanese Patent No. 2,746,567 (Reference 3) discloses a method of dripping glass melt from an outlet pipe, receiving the droplet in a mold having an indentation, and while floating the droplet by means of gas, forming the droplet into a spherical shape while in a state of essentially no contact with the inner surface of the indentation. This method permits the obtaining of a preformed glass material of highly precise weight having a surface free of defects such as scratches and contaminants.

However, the above-mentioned methods present the following problems. In the method of obtaining a glass material by precision press molding simply by cold processing glass blocks, numerous processing steps are required to manufacture a glass block of large dimensions (for example, an external shape of 50 cm or more) into a glass material of small dimensions (for example, from several millimeters to about 20 mm). Further, the processing allowance to be removed in the course of processing the glass block to prescribed size or shape constitutes from about ⅕ to ½ of the volume of the final glass material obtained, which is high. Thus, the processing takes time, considerable material is consumed in processing, and a large amount of waste product (glass shavings, glass grindings, or a grinding slurry that is difficult to reuse) is produced. In particular, many optical glasses incorporate large quantities of transition metal oxides and heavy metal oxides to achieve desired optical characteristics. Thus, disposal and processing present environmental issues. Further, since the shape of the cubic or cylindrical glass material differs greatly from the shape of the optical element that is being molded and is of inadequate surface smoothness, molding efficiency is poor and optical properties such as surface precision are inadequate.

In the method described in Reference 1 above, a glass gob that is nonuniform in shape (distorted) with an unsmooth surface is employed as a starting material and is ground into a prescribed shape. In the same manner as in the above method where a glass block is cold processed by cutting and grinding, there are problems in that the grinding allowance is large, production efficiency is poor, and a large quantity of grinding dust is discharged.

In the method described in Reference 2 above, multiple steps are required: (1) the step of cutting the glass material into a cylinder of a certain volume; (2) the step of heating the glass to above its softening temperature with far infrared radiation to deform the glass into a approximately spherical shape; (3) the step of barrel polishing the glass into a sphere; (4) and the step of processing the surface to a mirror finish. The processing into a approximately spherical shape by means of a heat treatment is described. However, the glass material of the approximately spherical body is comprised of a cylindrical lateral surface and two quasispherical surfaces as shown in FIG. 6 of Reference 2 (the same figure is shown as FIG. 7 in the present application) due to contact with a jig. This shape differs from that of a sphere. Multiple cold processing steps thus become necessary. This is problematic in that the processing allowance, at 1.2 mm or more along the outer diameter and 44 percent or more in terms of weight, is quite large.

In the method described in Reference 3, the following problems are encountered in obtaining a spherical glass material (spherical preform).

When the glass material contains volatile components, surface striae sometimes form on the glass spheres obtained by dripping and shaping. These are thought to result from nonuniformity of the refractive index due to a slight difference in composition between the surface and the interior due to volatilization of glass components occurring on the surface of the glass during the glass material forming step. For example, in fluorophosphate glass, which is a low-dispersion glass (with an Abbé number ν d of greater than or equal to 60, for example), surface striae tend to occur quite readily on the glass spheres due to volatilization of fluorine. Even when boric acid is incorporated as a glass network component, volatilization of the boric acid tends to cause surface striae. An alkali component is sometimes incorporated to effectively lower the softening temperature and obtain an optical glass suited to precision press molding. However, in that case, as well, the alkali component is volatile and tends to cause surface striae in the glass spheres.

In high refractive index glasses (glasses with an Abbé number ν d of greater than or equal to 1.7, for example), the high refractive index portion is contained in large quantity, so the quantity of glass network component is necessarily small and the liquidus temperature rises. Since the softening temperature also tends to rise, it becomes necessary to lower the softening temperature by incorporating a large amount of alkali component. Generally, when a large quantity of alkali component is incorporated, the thermal stability of the glass decreases. Thus, the liquidus temperature tends to end up even higher. When such optical glass is employed in the hot shaping of glass spheres, it is necessary to make the glass flow at a temperature of greater than or equal to the liquidus temperature to prevent crystallization. When the outflow temperature is high, the amount of glass component volatizing during that period increases to a level that cannot be ignored, causing surface striae. Due to the high outflow temperature, the viscosity of the glass during shaping of the glass melt decreases and bubbles tend to enter the surface of the glass sphere with impact during dropping or in the course of rendering the glass spherical by rotating the glass melt. Such bubbles due to the forming operation tend to form in the extreme outer surface of the glass sphere. Optical glass that is of low viscosity during dripping tends to be high refractive index glass.

Due to glass characteristics such as those set forth above, there are problems in that an optically inhomogeneity layer containing striae and bubbles near the surface tends to form in the method described in Reference 3, and glass compositions suited to mass production are limited. When a glass sphere having an optically inhomogeneity layer with surface striae and bubbles on its surface in this manner is employed, a negative effect is often exerted on the optical performance of the optical glass element obtained.

In particular, high value-added glass of high refractive index is often employed in pickup lenses for high-density optical information recording and reproduction and in the lenses of small or thin photographic apparatuses (digital camera lenses, camera lenses mounted in portable telephones). High quality is demanded of such lenses. Thus, when glass preforms having an optically inhomogeneity layer such as set forth above are employed as a glass material to mold such optical elements, there are cases where optical glass elements of desired quality cannot be obtained. Accordingly, the obtaining of glass preforms without optically inhomogeneity layers has been an issue.

Accordingly, the object of the present invention is to provide glass preforms (a glass material) not having an optically inhomogeneity layer by a simple method. A further object of the present invention is to provide a method of manufacturing optical glass elements with good optical performance from glass preforms (glass material) not having an optically inhomogeneity layer.

### BRIEF SUMMARY OF THE INVENTION

The present invention relates to a method of manufacturing precision glass spheres comprising the steps of:

dripping glass melt on a receiving mold to form the dripped glass melt gobs into a crude glass spheres; and

removing an optical inhomogeneity layer generated on the surface of the crude glass spheres.

In the method of manufacturing of the above invention, the following embodiments are preferred:
1. the surface waviness of the crude glass spheres is less than or equal to 50 micrometers;
2. the crude glass spheres comprise an optical glass having a viscosity of less than or equal to 50 dPa·s at the liquidus temperature;
3. the crude glass spheres comprise fluorophosphate glass, phosphate glass, or borate glass;
4. the crude glass spheres comprise optical glass having a liquidus temperature of greater than or equal to 900° C.;
5. the crude glass spheres comprises an optical glass having a refractive index nd of greater than or equal to 1.7 and a dispersion ν d of greater than or equal to 60;
6. the optical inhomogeneity layer is a layer containing striae or bubbles;
7. the removal of the optical inhomogeneity layer is carried out by removing glass to a depth ranging from 5 to 500 micrometers from the surface of the crude glass spheres; and
8. the removal of the optical inhomogeneity layer is carried out by polishing.

The present invention further relates to a method of manufacturing optical glass elements comprising press molding of a heat-softened glass material using a pressing mold the shape of which has been precision processed based on the shape of the optical element to be obtained, wherein a precision glass sphere manufactured according to the above-mentioned method of the present invention is employed as the glass material.

### BRIEF DESCRIPTION OF THE DRAWINGS

FIG. 1 shows an example of a device forming a glass gob into a crude glass sphere.

FIG. 2 shows an example of a device forming a glass gob into a crude glass sphere and a forming scheme.

FIG. 3 is a descriptive drawing of the step of polishing a crude glass sphere.

FIG. 4 is a descriptive drawing of a flat disk system for polishing crude glass spheres.

FIG. 5 is a descriptive drawing of a V-groove disk system for polishing crude glass spheres.

FIG. 6 is a descriptive drawing of the dimensions of a crude glass sphere and a precision glass sphere.

FIG. 7 shows the shape of the approximately spherical glass material for molding shown in FIG. 6 of Reference 2.

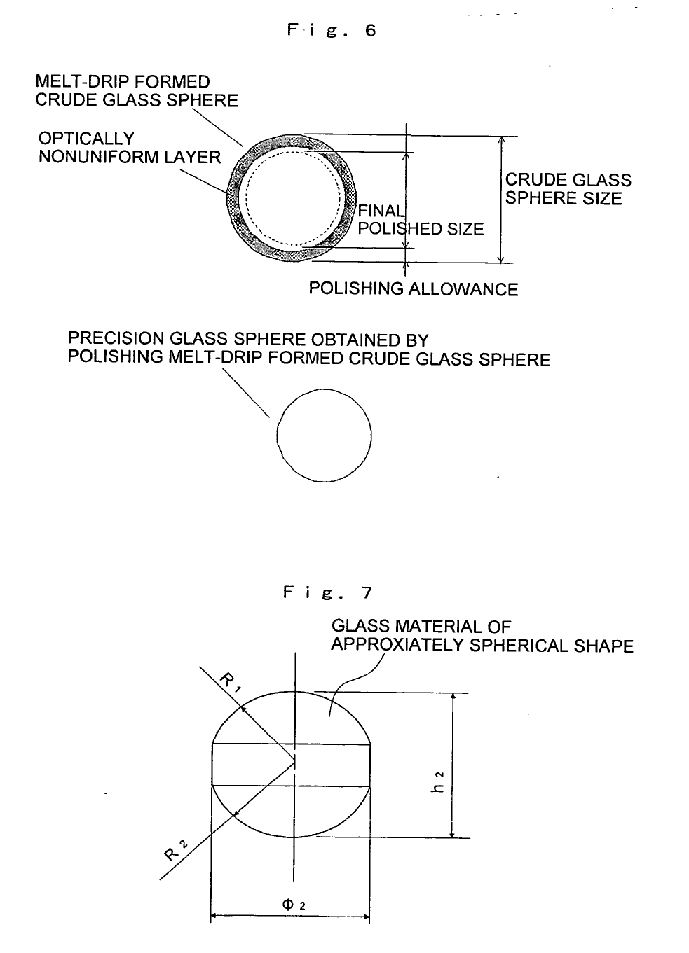

### DETAILED DESCRIPTION OF THE INVENTION

In the present invention, a crude glass sphere slightly larger than the dimensions of a desired precision glass sphere is formed by dripping glass melt, and an optically inhomogeneity layer formed on the surface thereof is removed by polishing to manufacture a precision glass sphere. By forming on a receiving mold the glass melt gob obtained by dripping, a crude glass sphere having approximately adequate surface smoothness can be shaped, readily yielding a crude glass sphere in which the variation in shape precision is within tolerances for a glass material used in precision press molding, with dimensions that are only slightly larger than those after final finishing. Accordingly, since it suffices to remove from the surface only the portion corresponding to the optically inhomogeneity layer in the polishing process and since the polishing allowance is quite small, advantages are achieved in the form of production efficiency and a reduction in the glass slurry discharged, the latter also being environmentally desirable. Further, it is difficult to eliminate throughout mass production the generation in some glasses of an optically inhomogeneity layer on the crude glass sphere caused by hot forming in the process of producing the glass material employed in precision press molding. However, the present invention provides a glass material not having an optically inhomogeneity layer for use in precision press molding, which is of great significance to mass production.

The method of manufacturing precision glass spheres of the present invention comprises the steps of dripping glass melt and forming the dripped glass melt gobs on a receiving mold to form crude glass spheres; and removing an optically inhomogeneity layer that is present on the surface of the crude glass spheres to obtain glass spheres (precision glass spheres) not having an optically inhomogeneity layer.

In the present invention, a glass melt is first dripped and the dripped glass melt gobs are formed on a receiving mold to obtain crude glass spheres. A glass melt obtained by melting, clarifying, and homogenizing glass starting materials can be directly employed, or the glass starting materials can be melted, clarified, and homogenized, and optical constants controlled to obtain cullets which are then melted.

The dripping of the glass melt is desirably conducted by causing glass melt to drip from an outlet pipe. The dripping glass melt is separated into prescribed units and received by the receiving mold as glass gobs. The term “dripping” includes the following forms. The glass gob is separated by, for example, allowing it to fall naturally onto the receiving mold as a glass droplet. Alternatively, the glass is made to flow out onto the receiving mold and is separated by surface tension, surface tension and gravity, downward movement of the receiving mold, or a cutting means.

The forming of the glass gob into a crude glass sphere is desirably accomplished while floating the glass gob either continuously or temporarily over the receiving mold by means of gas blown out of the receiving mold. The floating state of the glass gob on a gas does not necessarily preclude all contact with the surface of the receiving mold, but includes a state where there is repeated instantaneous contact with the surface of the receiving mold while being supported by the blown gas. Even when the crude glass sphere formed by this method has surface waviness, it is less than or equal to 50 micrometers.

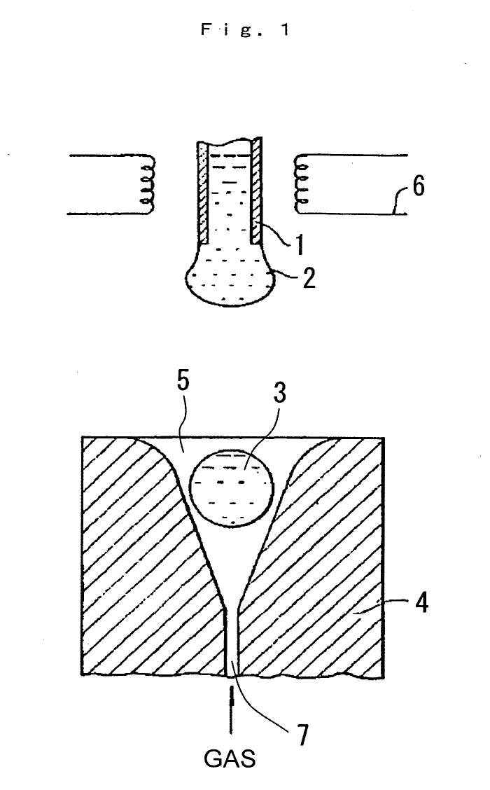

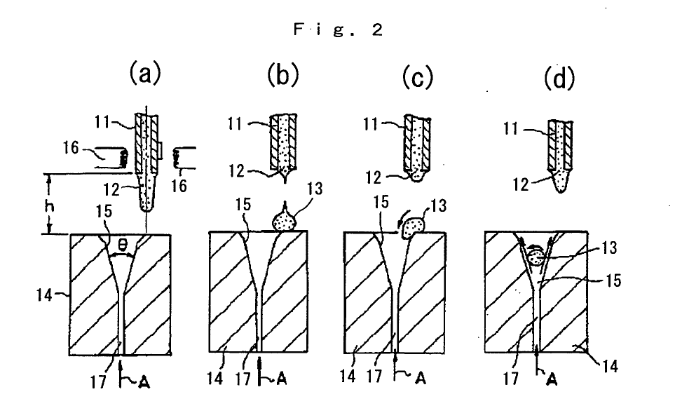

A device such as that shown in FIG. 1 or FIG. 2(a) to (d), for example, may be employed to form the glass gobs into crude glass spheres.

In the device of FIG. 1, glass melt 2 is caused to drip naturally from an outlet pipe 1 of platinum or the like, or made to fall by cutting with a blade, and the glass melt gob 3 is received in indentation 5 of receiving mold 4. Outlet pipe 1 can be maintained at a suitable temperature by a heater 6 provided around it. In the course of glass melt gob 3 being received in indentation 5 of receiving mold 4, a gas is blown out through a fine hole 7 provided in indentation 5, and with glass melt gob 3 in a floating state, a gas layer is formed between it and indentation 5. In this manner, glass melt gob 3 and indentation 5 are maintained in a state of essentially noncontact until the surface of glass melt gob 3 drops to a temperature less than or equal to the softening point.

In the device of FIG. 2, glass melt 2 dropping from outlet pipe 11 is received by the receiving member of a receiving mold. Subsequently, glass gob 13 is held in the indentation 15 of receiving mold 14. A fine hole 17 that blow gas are provided in indentation 15, and the glass gob 13 being held floats on gas A in a state of essentially noncontact with indentation 15 until the glass surface drops to or below the softening point.

In each of the above-described devices, the indentation of the receiving mold is tapered. The taper angle can be set within a suitable range based on the size of the dripping glass gob and the viscosity of the glass. A taper angle falling within a range of approximately 5° to 40° is suitable. The inner surface of the taper is desirably processed to a mirror surface finish to impart a smooth surface to the crude glass sphere. However, in the steps of the present invention, so long as the surface is one to which the glass will not adhere or fuse, a mirror surface is not necessarily required. The gas that is blown out may be air, but a gas that does not react with the surface of the glass gob is preferred. For example, an inert gas such as nitrogen, helium, or argon, or some mixture thereof, may be employed.

The inner diameter of the nozzle of the outlet pipe can be from 0.2 to 10 mm. The temperature of the outlet pipe is suitably controlled. The viscosity is regulated so that glass drips at a constant flow rate and at precise volume from the outlet pipe. The viscosity of the glass when dripping is desirably from 1 to 80 dPa·s, preferably from 2 to 50 dPa·s. Formed crude glass spheres with a diameter of about 1 to 10 mm can be produced. Particularly when the diameter is small (1 to 5 mm), it is desirable for the inner diameter of the nozzle to be from 0.2 to 3 mm. Glass droplets are desirably dripped sequentially and continuously from such an outlet pipe. Multiple receiving molds are employed to receive the glass droplets, each being positioned sequentially at the dripping location, receiving glass, and then withdrawing from beneath the outlet pipe. The glass gobs can be formed while being floated by gas.

The quantity of glass dripping down is controlled by a known method such as by controlling the temperature of the pipe out of which the glass melt flows. The quantity of glass dripping down is equal to the quantity of the desired preform (based on the dimensions of the precision glass sphere) when press molding optical elements plus a prescribed amount. That is, since an optically inhomogeneity layer is removed from the crude glass sphere in the next step, the crude glass sphere must be made larger than the precision glass sphere by at least the amount of the optically inhomogeneity layer that is removed. For example, when the shape of the glass dripping down is spherical, the dimensions of the dripping and formed crude glass sphere can be made to have a radius that is 5 to 500 micrometers larger than the radius of the desired precision glass sphere. Further, when the glass gobs are being continuously dripped and numerous crude glass spheres are being continuously formed, dimensional variation of the crude glass spheres is desirably kept to a dimensional precision of within ±5 percent of the targeted radius of the above-described crude glass sphere.

The crude glass spheres can be formed into the shape of true spheres or oblate spheres. That is, they are preferably formed into true spheres or to a shape with a precision permitting processing by the tumble polishing method in the sphere polishing step. Even when there is a difference in length to the shape, such as in oblate spheres, it is desirable for the ellipticity (letting “a” denote the major axis and “b” the minor axis, ellipticity θ=sin₋₁(a/b)) to be greater than or equal to 60° from the perspective of rolling on a polishing disk. The difference between the major and minor axis is desirably less than or equal to 500 micrometers.

As stated above, the floating state of the glass gob on the receiving mold does not fully preclude contact with the surface of the receiving mold, but includes the state where there is repeated instantaneous contact with the surface of the receiving mold while the glass gob is being supported by blown gas. Thus, as stated above, crude glass spheres having a surface waviness of less than or equal to 50 micrometers can be obtained.

When applying the above-described steps to the above-described glass and forming crude glass spheres, an optically inhomogeneity layer often forms on the surface. Even when the forming conditions are strictly optimized, it is impossible to completely avoid the generation of an optically inhomogeneity layer throughout the mass production process. Here, what is being referred to as an optically inhomogeneity layer is, for example, a layer containing striae or bubbles, for example, with a refractive index, surface reflectance, or transmittance differing from that of the interior portion of the glass. The term striae refers to portions where the refractive index is locally nonuniform due to nonuniformity of the glass composition or density. When striae are present in the glass material (for example, spherical glass preforms) employed in precision press molding, a portion of nonuniform refractive index, transmittance, or reflectance remains in the optical element (for example, a lens) following press molding, degrading optical performance. Thus, no optically inhomogeneity layer may be present in the crude glass spheres constituting the glass material.

However, research conducted by the present inventors led to the discovery that striae tend to develop near the surface, depending on the glass composition. For example, this occurs when employing an optical glass containing a volatile component. Examples of such glasses are fluorophosphate glass and borate glass. With fluorophosphate glass, since fluorine near the surface volatizes as hydrofluoric acid, a layer differing in composition from the glass on the interior forms on the surface, and nonuniformity in refractive index tends to result. Further, when boric acid is incorporated as a glass network component (for example, in lanthanum borate glass), surface striae tend to form because of volatizing boric acid. Still further, since alkali components (lithium is particularly effective) that are added to lower the glass softening point are also volatile components, the same problem tends to occur.

Glasses having high liquidus temperatures are further examples. These include glasses with liquidus temperatures of 900° C. or greater, specifically temperatures ranging from 900 to 1,200° C. In particular, large quantities of high-refractive index components such as Ti, Nb, W, and Bi are incorporated in glasses having high refractive indexes (such as glasses having a refractive index nd of greater than or equal to 1.7), while the quantity of glass network components contributing to the stability of the glass is low relative to other glasses. For example, this tendency is pronounced in optical glasses manufactured from formulas in which the total quantity of network components (silicic acid, boric acid, or phosphoric acid) is less than or equal to 50 weight percent and in extreme cases, such as when the quantity is less than or equal to 25 weight percent. Since such optical glasses flow out at temperatures near their liquidus temperatures, there is considerable volatilization of glass components between dripping into the receiving mold and solidification, and surface striae tend to occur.

In phosphate-based glasses, the glass wets and sticks to the tip of the outlet pipe due to a high wetting affinity for the platinum used in the dripping outlet pipe. When that happens, glass adhering to and remaining in the vicinity of the tip of the outlet pipe undergoes a change in composition due to volatilization and mixes in small amounts back into the glass that is flowing out. Thus, the composition of the surface of the glass dripping down varies nonuniformly. In such cases as well, striae tend to form on the surface of the preforms.

Bubbles on the surface of the preform are also a problem as an optically inhomogeneity layer. When the viscosity of the glass melt dripping down is low, impact when the dripping glass droplets come into contact with the receiving mold or impact when they move due to the flow of blown gas tends to cause bubbles to form on the surface. In particular, this problem tends to occur in optical glass having a viscosity of 20 dPa·s or less at the liquidus temperature. Since dripping of these optical glasses, that is, the same high refractive index glasses as set forth above, is often conducted at low viscosity, there is a particular need for a countermeasure to bubbles in high refractive index glasses.

When the crude glass spheres have small diameters of less than or equal to 5 mm, the range of conditions permitting the stable forming of preforms tends to be narrow.

In crude glass spheres obtained from glasses such as those set forth above, or dripped and formed under conditions such as those set forth above, an optically inhomogeneity layer often forms to a depth of less than 500 micrometers from the surface. When an attempt is made to remove the optically inhomogeneity layer, a long period is either required to optimize the forming conditions, or conditions close to the outflow limit are reached and a stop must be made part way through, compromising the yield. There are some glasses for which suitable conditions do not exist. When such crude glass spheres are employed as preforms to obtain optical elements such as lenses and used in precision press molding, an optically inhomogeneity layer ends up remaining on the surface of the optical element that has been press molded. This layer causes transmitted wave front waviness, reduced transmittance, increased scattered light, and the like, and ends up degrading the optical performance of the optical element.

However, the nonuniformity in surface shape (surface waviness) is small in crude glass spheres that have been thus dripped and formed. When the optically inhomogeneity layer formed on the surface is removed, the crude glass spheres have adequate properties for use as glass preforms in press molding. That is, the crude glass spheres of the present invention have a surface waviness of 50 micrometers or less. The surface waviness referred to here is the maximum surface waviness based on the JIS B 610 standard. For example, it is the value expressed for a portion obtained by cutting out a reference length of 500 micrometers.

Accordingly, to remove the optically inhomogeneity layer remaining on crude glass spheres in the present invention, glass corresponding to the thickness of the optically inhomogeneity layer is removed by surface polishing, for example, yielding precision glass spheres without the optically inhomogeneity layer. The precision glass spheres are then processed to final finished dimensions allowing them to be directly employed as preforms. Further, it is desirable for the surface of the crude glass spheres to be uniformly removed to a certain thickness.

The method of polishing is not specifically limited. However, the above crude glass spheres are formed to impart a spherical shape permitting rolling. Thus, the removal of the optically inhomogeneity layer is desirably conducted by tumbling with a polishing disk. The optically inhomogeneity layer is normally present in the portion within 500 micrometers of the surface. Accordingly, the amount removed by polishing can be kept to 500 micrometers or less. Further, the radius of the crude glass spheres is suitably made about 5 to 500 micrometers larger than the diameter (final finished dimensions) of the desired preform in press molding because of the removal of the optically inhomogeneity layer.

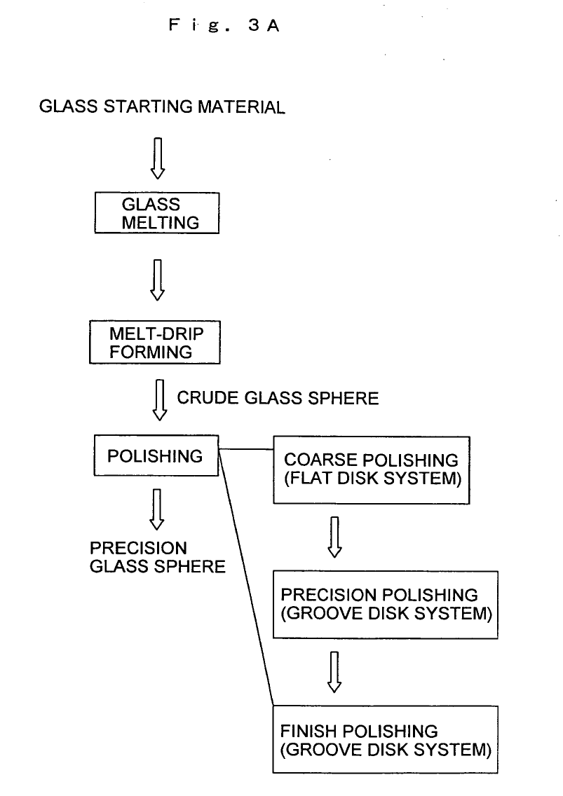

As shown in FIG. 3A, for example, the above polishing step may be in the form of the three steps of (1) coarse polishing, (2) precision polishing, and (3) finish polishing. As stated above, a polishing allowance of from 5 to 500 micrometers is suitable. When the optically inhomogeneity layer of the crude glass spheres is of slight thickness (less than or equal to about 100 micrometers), the coarse polishing step is desirably omitted and, as shown in FIG. 3B, precision polishing and finish polishing are conducted. When the thickness of the optically inhomogeneity layer is even smaller (less than or equal to about 10 micrometers), the coarse polishing and precision polishing steps can be omitted, and, as shown in FIG. 3C, only the finish polishing conducted.

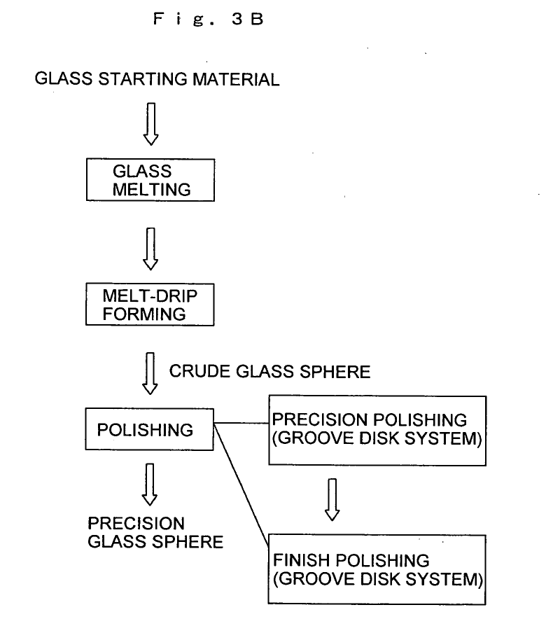

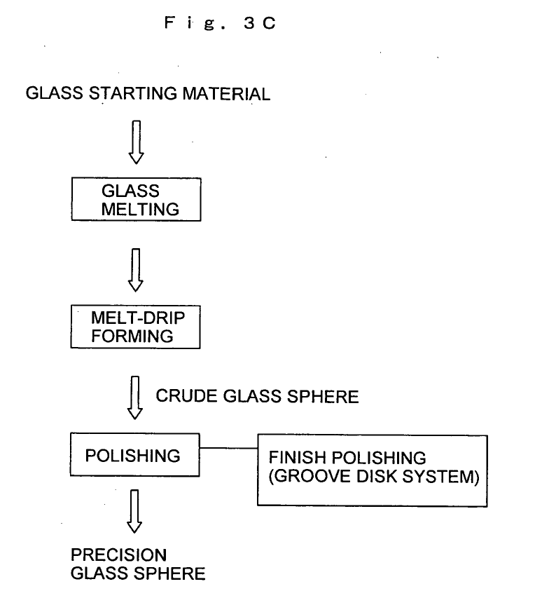

Polishing may be conducted in the form of tumble polishing. In tumble polishing, the spheres are sandwiched between two rotating polishing disks and polished while being tumbled. The polishing disks may be in the form of two flat disks that sandwich the spheres (see FIG. 4 for the form of the two flat disks), or one of the two polishing disk surfaces may be grooved (for example, V-grooved in FIG. 5 in a V-grooved disk method) and used to sandwich the spheres with another flat polishing disk, with the spheres passing through the grooves (see FIG. 5). In the latter case, the spheres are polished by being made to turn in the interior of the grooves while being supported by the three points of the flat disk and the lateral surfaces of the grooves. Thus, while the spheres are rotating in the grooves, the axis of rotation is changed, and the protruding portions on the surface of the spheres is polished away. As polishing progresses, the spheres are uniformly polished, with the dimensional precision and shape precision of the spheres gradually increasing. The grooves provided in the surface of the polishing disk are not limited to V-grooves; any groove shape permitting support of the crude spheres by two lateral groove surfaces will suffice.

In coarse polishing of the crude glass spheres in the polishing step to remove the optically inhomogeneity layer in the present invention, a system employing two flat disks at a relatively rapid polishing rate can be employed. In the precision and finish polishing, a V-groove disk system achieving high degrees of dimensional and shape precision is desirable.

Since the crude glass spheres of the present invention are comprised of optical glass, the use of aluminum oxide, cerium oxide, or zirconium oxide polishing grains is desirable to increase the polishing rate and enhance surface quality. Polishing grains with a diameter of about 0.01 to 100 micrometers are employed depending on the polishing step. In finish polishing, polishing grains with a diameter of less than or equal to 5 micrometers are desirably employed. In particular, when low surface roughness and small scratches and digs are desired, polishing grains with a diameter of less than or equal to 1 micrometer are employed. Colloidal silica, silicon carbide, diamond, and the like may be employed as the polishing grains.

The polishing fluid used to process the spheres may be obtained by mixing the polishing grains with water or an alkali aqueous solution to form a suspension or slurry. The processing fluid may be suitably fed, dripped, or sprayed onto the polishing disks.

The polishing conditions are such that a polishing load ranging from 5 to 20 gf is applied per spherical body and the polishing disks are rotated at a speed ranging from 100 to 300 rpm. These conditions may be suitably adjusted based on the number and size of the crude glass spheres being polished and the composition of the glass.

The polishing rate (removal rate) may be set to about 1 to 200 micrometers/hour, for example. Since the polishing rate is higher in the flat disk method than when using the grooved polishing disk method, it is suited to coarse processing. Since a low polishing rate of less than or equal to 10 micrometers/hour is possible by the grooved polishing disk method, it affords the advantage of permitting precise control of the amount of polishing (dimension processing) based on the polishing time. Further, the grooved polishing disk method permits high-precision processing of sphere shape precision (surface waviness, degree of sphere contouring (sphericity)), and is thus suited to finish polishing.

Accordingly, the grooved polishing disk method can be used to polish the melt-drip formed crude glass spheres and reliably remove the optically inhomogeneity layer present on the surface of the spheres with a minimum polishing allowance (quantity removed by polishing).

Such polishing removes a portion corresponding to the optically inhomogeneity layer (a thickness of about 5 to 500 micrometers) on the surface. Preferably, the polishing allowance is made about 10 to 100 micrometers. The precision glass spheres obtained by polishing can be employed as glass preforms in precision press molding.

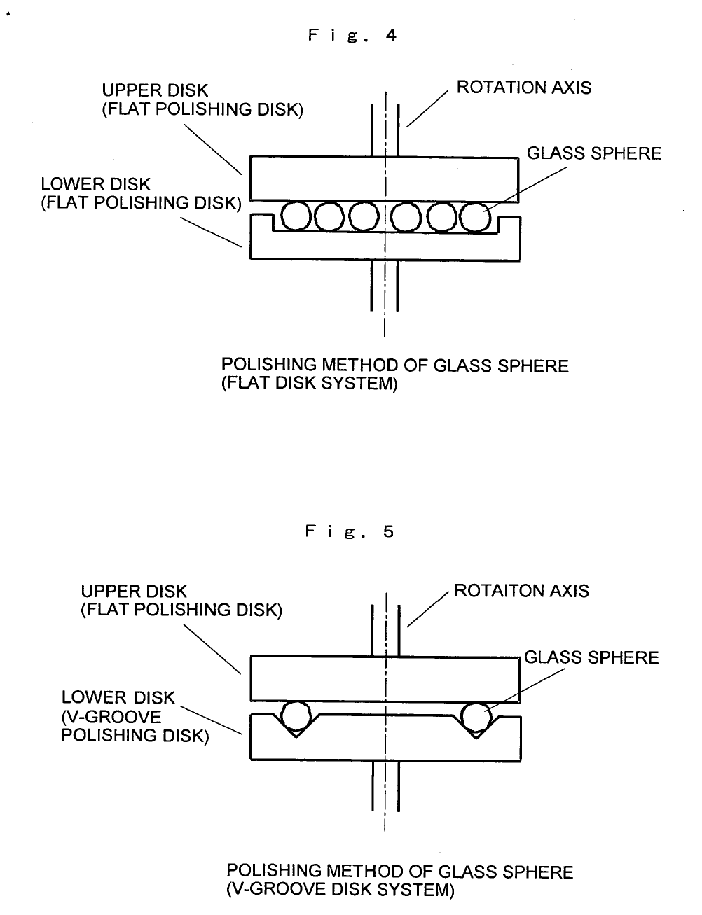

The final finished dimensions of the precision glass spheres can be determined based on the volume of the optical elements to be obtained by precision press molding. Specifically, the amount of volume removed following press molding by centering and edging can be added to the volume of the optical element to be obtained to obtain the volume of the glass preform to be employed in precision press molding. As shown in FIG. 6, for example, the size of the crude glass sphere is the sum of the final polished size (final finished size) and the thickness of the optically inhomogeneity layer.

The glass cutting step required in prior art is unnecessary in the present invention. Accordingly, scoring and cracking of the glass does not occur during cutting and slicing, so there is no need for a large polishing allowance. A portion corresponding to the thickness of the optically inhomogeneity layer is removed by polishing from the surface of crude glass spheres having approximately adequate optical flatness. Thus, not only is the polishing step highly efficient, but little glass dust is produced by polishing.

The composition of the glass employed in the present invention is not specifically limited, but the effect of the present invention is marked in glasses tending to generate an optically inhomogeneity layer as set forth above. Specific examples are optical glasses having a refractive index of from 1.7 to 2.2 and optical glasses having a dispersion ν d of 60 to 95. The glass compositions set forth above may also be given as examples. Further, the effect of the present invention is high in optical glasses having the above-stated liquidus temperature range. For example, the present invention is effective for glasses having a glass viscosity of less than or equal to 50 dPa·s, particularly 20 dPa·s, at the liquidus temperature.

Here, the liquidus temperature means the lowest temperature that can be maintained without precipitation of crystals when solid glass is heated at a rate of prescribed range and maintained at each temperature. The rate of prescribed range is, for example, 1 to 50° C./min.

The present invention includes a method of manufacturing optical glass elements. This manufacturing method comprises the press molding of a heat-softened glass material using a pressing mold, the shape of which has been precision processed based on the shape of the optical element to be obtained, and is characterized in that a precision glass sphere manufactured by the above-described method of the present invention is employed as the glass material.

The process in which a precision glass sphere according to the present invention is employed as a glass preform in precision glass molding to obtain an optical element by press molding will be described next.

A pressing mold obtained by precision processing a base material in the form of a dense material of adequate heat resistance and hardness—for example, a ceramic such as silicon carbide or silicon nitride, or an ultahard alloy—based on the surface shape of a desired optical element and imparting a mirror finish to it can be employed. A film having mold separation properties is desirably formed on the molding surface. The mold separation film employed may have a principal component in the form of carbon or a noble metal.

For example, a glass preform that has been heat softened to a viscosity suitable for molding is press molded between upper and lower pressing molds by applying suitable pressure to transfer the molding surface. While maintaining close contact with the molding surface, cooling is conducted at a prescribed rate to the vicinity of the transition temperature, preferably equal to or lower than the transition temperature, the molds are separated, and the press molded product is removed. At that time, since the preform is positioned between the upper and lower pressing molds, it can be heated together with the pressing mold (for example, to a temperature corresponding to a glass viscosity of 10⁸ to 10¹² dPa·s), or a preform heated outside the pressing mold (for example, to a temperature corresponding to a glass viscosity of 10⁶ to 10⁹ dPa·s) can be supplied between the heated pressing molds and press molded. In the latter case, the preform that has been heated outside the pressing mold can be supplied between pressing molds that have been heated to a somewhat lower temperature (for example, to a temperature corresponding to a glass viscosity of 10⁸ to 10¹² dPa·s), the upper and lower pressing molds immediately brought into contact, and a load applied to conduct press molding.

With the load still being applied, or with the load having been reduced, the molded optical element is kept in tight contact with the pressing mold, and once cooling has been conducted to or below a temperature corresponding to a glass viscosity of 10¹² dPa·s, the upper and lower pressing molds are separated and the product is removed from the molds. Separation from the mold is desirably conducted at a temperature corresponding to 10^{12.5} to 10^{13.5} poises.

The shape of the optical element molded by application of the present invention is not specifically limited. However, since the use of a spherical preform is particularly advantageous for biconvex lenses and convex meniscus lenses, the present invention is highly effective. The precision glass sphere obtained according to the present invention may be employed in optical communication ball lenses, rod lenses, optical pickup hemispherical lenses, and the like.

[Embodiments]

The Present Invention is Described in Greater Detail Below Through Embodiments.

Embodiment 1

Precision glass spheres for use in precision press molding were manufactured from lanthanum borate (B₂O₃—La₂O₅) glass A (glass components: 21 weight percent B₂O₃, 35 weight percent La₂O₅; refractive index 1.80 nd; ν d 40). First, the starting materials of the above glass were melted, vitrified, clarified, homogenized, and solidified to manufacture cullets of precisely controlled refractive index. A suitable quantity of cullets was remelted in a glass melting vat, caused to flow out, dripped, and formed.

The device shown in FIG. 1 was employed in the manufacturing of the crude glass spheres. An examination of the dripped and formed crude glass spheres following cooling revealed striae within 90 micrometers of the surface. Because lanthanum borate glass was employed, these were attributed to marked volatilization from the glass surface during dripping and forming. Continuous and stable forming under conditions capable of suppressing surface striae was not readily achieved. The surface waviness of the crude glass spheres was 10 to 20 micrometers. With regard to the size of the drip formed crude glass spheres, the quantity of dripped glass was adjusted to a diameter of 3 mm, which was about 0.300 mm larger than the 2.700 mm diameter of the final finished size.

Next, a polishing step was conducted to remove the surface striae of the drip formed crude glass spheres. The polishing step of the present embodiment comprised the three steps of: (1) coarse polishing; (2) precision polishing; and (3) employing a grooved polishing disk method (a V-groove polishing disk method was employed in the present embodiment).

First, in coarse polishing, the flat polishing disk method shown in FIG. 4 was employed. Crude glass spheres 3 mm in diameter were sandwiched between two flat polishing disks and placed in a polishing device. The polishing fluid employed was obtained by mixing silicon carbide (no. 400, grain diameter of about 75 micrometers) in water. In coarse polishing, the goal was to remove surface striae. A polishing rate of 100 micrometers/hour was achieved by adjusting the rotational speed of the polishing disks and the polishing load. The polishing time was controlled so that 0.1 mm per sphere radius was removed by polishing. As a result, the original 3.0 mm diameter of the crude glass spheres prior to coarse polishing become on average 2.8 mm following polishing.

Next, precision polishing was conducted by the V-groove disk method shown in FIG. 5. Crude glass spheres 2.8 mm in diameter were set in V grooves, a flat polishing disk was positioned as the upper disk, sandwiching the spheres, and the entire assembly was positioned on a polishing device. The polishing fluid employed was obtained by mixing aluminum oxide (no. 2000, grain diameter of about 19 micrometers) in water. A polishing rate of 30 micrometers/hour was achieved by adjusting the rotational speed of the polishing disks and the polishing load. Precision polishing was conducted so that the diameter following polishing was 2.710 mm, which was about 0.01 mm larger than the final finished size. Thus, the polishing time was controlled so that 0.045 mm per sphere radius was removed by polishing. As a result, the original 3.0 mm diameter of the crude glass spheres prior to coarse polishing became 2.710 mm following polishing.

Finish polishing was then conducted. The polishing fluid employed was obtained by mixing cerium oxide (grain diameter of about 0.5 to 1.0 micrometer) in water, and was poured into V grooves. A polishing rate of 5 micrometers/hour was achieved by adjusting the rotational speed of the polishing disks and the polishing load. Finish polishing had to be conducted so that the diameter following polishing fell within the final finished diameter of 2.700 mm±0.001 mm. Thus, the polishing time was controlled so that 0.005 mm per sphere radius was removed by polishing. The polishing time was precisely controlled. As a result, the original 2.710 mm diameter of the crude glass spheres prior to precision polishing became a maximum diameter of 2.7002 mm, minimum diameter of 2.7000 mm, and average diameter of 2.7001 after polishing. Relative to the targeted final finish size, the processing error was within ±0.0005 mm, yielding high-precision spherical preforms.

The preforms thus obtained were employed in precision press molding to mold optical pickup object lenses (high NA object lenses for blue laser optical pickups).

(Design and Specifications of Molded Lenses)

The lens designed in the present embodiment was a convex meniscus lens. It was an infinite system single-element lens having a double aspherical surface shape with a design wavelength λ of 405 nm, an NA of 0.85, a focal distance of 1.77 mm, a working distance of 0.6 mm, an outer lens diameter of 3.7 mm, an effective diameter of 3.0 mm, a center thickness of 2.0 mm, a first surface radius of curvature of 1.35 mm, and a second radius of curvature of 6.43 mm.

The quality of the external appearance of the lens was quite high with respect to factors decreasing performance due to nonuniformity of the refractive index of the lens surface (glass surface striae) such as nonuniformity or local increases in transmitted wave front waviness and lens reflectance, and factors compromising the light converging performance of the optical pickup. Actually, no lens surface striae were observed in a visible light magnification examination.

Lens performance and precision glass molding properties were considered and optimized in the lens design. However the design wavelength was a low 405 nm and the NA of 0.85 was high, so the design was one of extremely strict permissible error in lens size and shape precision. In reality, to keep wave front aberration within 0.04 λrms, spherical surface aberration had to be kept to within about 0.01 to 0.02 λrms. Thus, the center thickness precision of the lens was kept to within ±1 micrometer.

(Pressing Method and Pressing Conditions)

A concave mold for molding the first surface of the lens was employed as the lower mold and a concave mold for molding the second surface of the lens was employed as the upper mold. Next, a preform was set on the concave surface of the lower mold, the molds were heated, and when the pressing temperature was reached, a pressing load was applied to transfer the shape of the mold surfaces. Through adequate extension of the glass, it was brought into tight contact with the molding surface. Once the interior of the mold had been filled with a prescribed volume of glass, the molds were cooled to or below the vicinity of the glass transition temperature. Finally, the molded lens was separated from the mold and removed.

The following pressing conditions were employed to achieve the thermal characteristics and viscosity characteristics of the glass (a glass yield point Ts of 600° C., a glass transition point Ts of 560° C., and the like), desired lens dimensions and shape, and correct and highly precise transfer of the molding surfaces.

| | |
|---|---|
| Pressing temperature: | 650° C. |
| Pressing pressure: | 180 to 200 kgf/cm² |
| Pressing load: | 100 to 150 kgf |
| Mold separation temperature: | 520° C. |

(Pressing Results)

Striae were completely removed from the preform employed in press molding by precision polishing. Visual inspection revealed no surface striae, bubbles, or other defects due to nonuniformity in the refractive index of the glass surface.

Since the diameter of the preform employed in press molding was highly precise and since the variation in preform volume was extremely low, defects in the shape of the molded surface due to insufficient glass filling, product defects such as glass oozing from the mold due to overfilling of glass, and manufacturing problems such as damage to the molds did not occur.

In the continuous molding of 1,000 lenses, the wave front aberration value was a minimum of 0.021 λrms, a maximum of 0.035 λrms, and an average of 0.028 λrms. Thus, stable performance was obtained even in high NA single lenses with extremely narrow permissible error margins in manufacturing.

1. A method of manufacturing precision glass spheres comprising the steps of:
dripping glass melt on a receiving mold to form the dripped glass melt gobs into a crude glass spheres; and
removing an optical inhomogeneity layer generated on the surface of the crude glass spheres.

2. The method of manufacturing according to claim 1, wherein the surface waviness of the crude glass spheres is less than or equal to 50 micrometers.

3. The method of manufacturing according to claim 1, wherein the crude glass spheres comprise an optical glass having a viscosity of less than or equal to 50 dPa·s at the liquidus temperature.

4. The method of manufacturing according to claim 1, wherein the crude glass spheres comprise fluorophosphate glass, phosphate glass, or borate glass.

5. The method of manufacturing according to claim 1, wherein the crude glass spheres comprise optical glass having a liquidus temperature of greater than or equal to 900° C.

6. The method of manufacturing according to claim 1, wherein the crude glass spheres comprises an optical glass having a refractive index nd of greater than or equal to 1.7 and a dispersion ν d of greater than or equal to 60.

7. The method of manufacturing according to claim 1, wherein the optical inhomogeneity layer is a layer containing striae or bubbles.

8. The method of manufacturing according to claim 1, wherein the removal of the optical inhomogeneity layer is carried out by removing glass to a depth ranging from 5 to 500 micrometers from the surface of the crude glass spheres.

9. The method of manufacturing according to claim 1, wherein the removal of the optical inhomogeneity layer is carried out by polishing.

10. A method of manufacturing optical glass elements comprising press molding of a heat-softened glass material using a pressing mold the shape of which has been precision processed based on the shape of the optical element to be obtained, wherein a precision glass sphere manufactured according to the method described in claim 1 is employed as the glass material.

11. A method of manufacturing optical glass elements comprising press molding of a heat-softened glass material using a pressing mold the shape of which has been precision processed based on the shape of the optical element to be obtained, wherein a precision glass sphere manufactured according to the method described in claim 2 is employed as the glass material.
